(19) United States
(12) Patent Application Publication
(10) Pub. No.: US 2016/0070846 A1
(43) Pub. Date: Mar. 10, 2016

(54) SYSTEM FOR TESTING IC DESIGN

(71) Applicants: Nandini, Noida (IN); Rohit Srivastava, Noida (IN)

(72) Inventors: Nandini, Noida (IN); Rohit Srivastava, Noida (IN)

(73) Assignee: Freescale Semiconductor, Inc., Austin, TX (US)

(21) Appl. No.: 14/481,899

(22) Filed: Sep. 9, 2014

(51) Int. Cl. G06F 17/50

(52) U.S. Cl. CPC G06F 17/5081; G06F 17/5072

(57) ABSTRACT

A method for testing an integrated circuit design exercises the design using a set of simulation signals, and partitions a representation of the design into a first set of active elements and a second set of inactive elements. Only the active elements of the first set are exercised using a second set of simulation signals during verification of the integrated circuit design.

### BACKGROUND OF THE INVENTION

The present invention relates to testing of integrated circuit designs and, more particularly, to a system for testing and partitioning an integrated circuit design.

The testing and verification of complex systems such as a System-on-Chip (SoC) face at least two challenges. A first challenge is the significant compile time needed in advance of simulating the design to ensure that the design is comprehensively exercised during simulation. A second challenge, following compilation, is the subsequent runtime experienced during simulation. The extent or coverage of the simulation is at least a factor behind the significant compile times and runtimes. Long verification test-bench simulations on large system level test scenarios require extensive runtime on supporting servers, which, in turn, can impact design cycle time and the time to market for a SoC design. Thus, it would be advantageous to have a system and method for testing an integrated circuit (IC) design that did not require such significant compile and runtimes.

### BRIEF DESCRIPTION OF THE DRAWINGS

The invention, together with objects and advantages thereof, may best be understood by reference to the following description of preferred embodiments together with the accompanying drawings in which:

FIG. 1 is a schematic block diagram of a conventional system for verifying a System-on-Chip design;

FIG. 2 is a schematic diagram illustrating a method for test signal reduction in accordance with an embodiment of the present invention;

FIG. 3 is a flow chart of a method for test signal reduction in accordance with an embodiment of the present invention;

FIG. 4 is a schematic block diagram of a system for verifying a System-on-Chip design according to an embodiment;

FIG. 5 is a view of stubbing aspects of a System-on-Chip according to an embodiment of the present invention;

FIG. 6 is a view of a stubbed System-on-Chip design according to an embodiment;

FIG. 7 is a schematic diagram of a system for verifying a System-on-Chip design according to an embodiment of the present invention;

FIG. 8 is a flow chart of a method for verifying a System-on-Chip design according to an embodiment of the present invention; and

FIG. 9 is a schematic block diagram of a computer system on which embodiments of the present invention may be realized.

### DETAILED DESCRIPTION OF PREFERRED EMBODIMENTS

The detailed description set forth below in connection with the appended drawings is intended as a description of presently preferred embodiments of the invention, and is not intended to represent the only forms in which the present invention may be practised. It is to be understood that the same or equivalent functions may be accomplished by different embodiments that are intended to be encompassed within the spirit and scope of the invention. In the drawings, like numerals are used to indicate like elements throughout. Furthermore, terms “comprises,” “comprising,” or any other variation thereof, are intended to cover a non-exclusive inclusion, such that module, circuit, device components, structures and method steps that comprises a list of elements or steps does not include only those elements but may include other elements or steps not expressly listed or inherent to such module, circuit, device components or steps. An element or step proceeded by “comprises . . . a” does not, without more constraints, preclude the existence of additional identical elements or steps that comprises the element or step.

In one embodiment, the present invention provides a method of testing and partitioning an integrated circuit design. The method includes exercising an initial design using respective simulation signals and then repartitions the design into a first set of elements having active elements, and a second set of elements having inactive elements. The method exercises only the active elements of the first set using a second set of simulation signals during verification of the design.

In other examples, embodiments provide methods of finding a reduced or minimum number of input signals of an IP, on which if an activity does not take place that indicates that the said block is inactive for the duration of the test-case run. IP means Intellectual Property but herein this term is as used by circuit design engineers, who use the term to refer to separate circuit blocks that have a fixed design. For example, a SoC may have a number of IPs, some being the same (e.g., core blocks in a multi-core circuit, and some different (e.g., memory blocks are different from core blocks).

In another embodiment, an apparatuses for testing an integrated circuit design is provided. The apparatus comprises a processor and a memory coupled to the processor. The memory is used to store the integrated circuit design. The processor is arranged for partitioning a representation of the design into a first set of elements comprising active elements and a second set of elements comprising inactive elements following a first exercising of the representation of the design using a first set of simulation signals, and exercising, using a second set of simulation signals, only the active elements of the first set of elements during verification of the integrated circuit design.

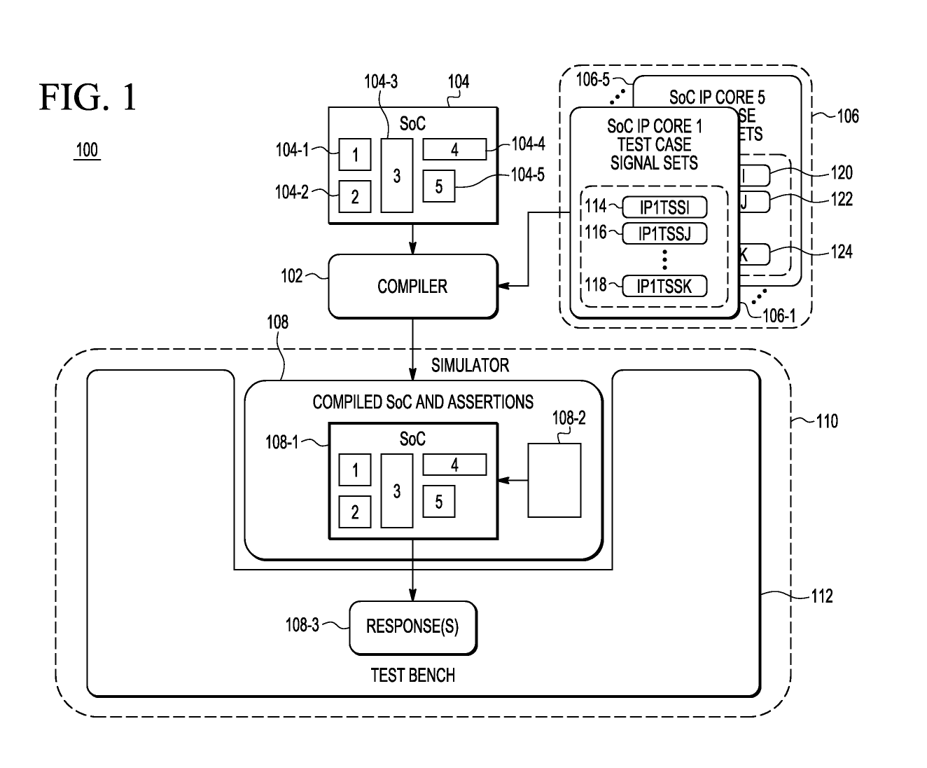

Referring now to FIG. 1, there is illustrated a prior art system 100 for verifying a System-on-Chip (SoC) design. The system 100 comprises a compiler 102 for compiling a description 104 of the System-on-Chip together with one or more than one or test case 106 comprising signals arranged to exercise the System-on-Chip description 104. The description can be expressed in an appropriate hardware description language. The compiler 102 is arranged to produce a compiled expression 108-1 of the SoC description 104 and any associated assertions 108-2 derived from the one or more than one test case 106. The system 100 further comprises a simulator 110 for exercising the compiled SoC expression and assertions 108. The simulator 110 has a test bench 112. The test bench 112 is arranged to process the compiled expression 108, which applies the compiled assertions 108-2 to the compiled SoC expression 108-1 and notes one or more than one response 108-3 of the compiled SoC expression 108-1 to the assertions 108-2.

The SoC description 104 comprises one or more than one IP core. An IP core is a unit or block of reusable circuitry such as, for example, logic. An IP core has a respective signal boundary that defines at least one of one or more than one input to and one or more than one output from the IP core.

In the illustrated embodiment, the SoC description 104 comprises a plurality of IP cores 104-1 to 104-5, that is, the SoC description 104 illustrated comprises five IP cores. However, the SoC description could equally well contain some other number of IP cores and, in practice, the SoC description 104 would typically contain at least tens or hundreds of IP cores.

The above one or more than one response 108-3 manifests itself as a change associated with at least one of the SoC or one or more than one of the SoC IP cores. The change can comprise a change in state of an IP core, which could be a change at a signal boundary associated with an IP core or a change of state of an element of the IP core. Such an element could comprise at least one of a register, an output signal or any other feature of the IP core taken jointly and severally in any and all permutations.

The one or more than one test case 106 is illustrated as comprising a plurality of test cases. In the embodiment illustrated there are five test cases 106-1 to 106-5; each relating to a corresponding IP core 104-1 to 104-5 of the SoC description 104. A test case, such as the first test case 106-1 comprises one or more than one assertion or signal to be applied to a respective IP core, such as the first IP core 104-1.

In the illustrated embodiment, the first test case 106-1 comprises a plurality of assertions or signals 114 to 118. The same applies to the fifth test case 106-5, which also comprises a plurality of assertions or signals 120 to 124. It will be appreciated that each test case 106 will be different and specific to a respective IP core. An IP core may have a plurality of associated test cases that could be applied in providing comprehensive testing and verification coverage.

In simulating the integrated circuit design, the compiler 102 processes the SoC description 104 and the IP core test 106 cases to produce the compiled SoC expression 108-1 and any associated assertions 108-2, which represents a significant compilation effort. Furthermore, such a sizable compilation also has a significant associated runtime during simulation.

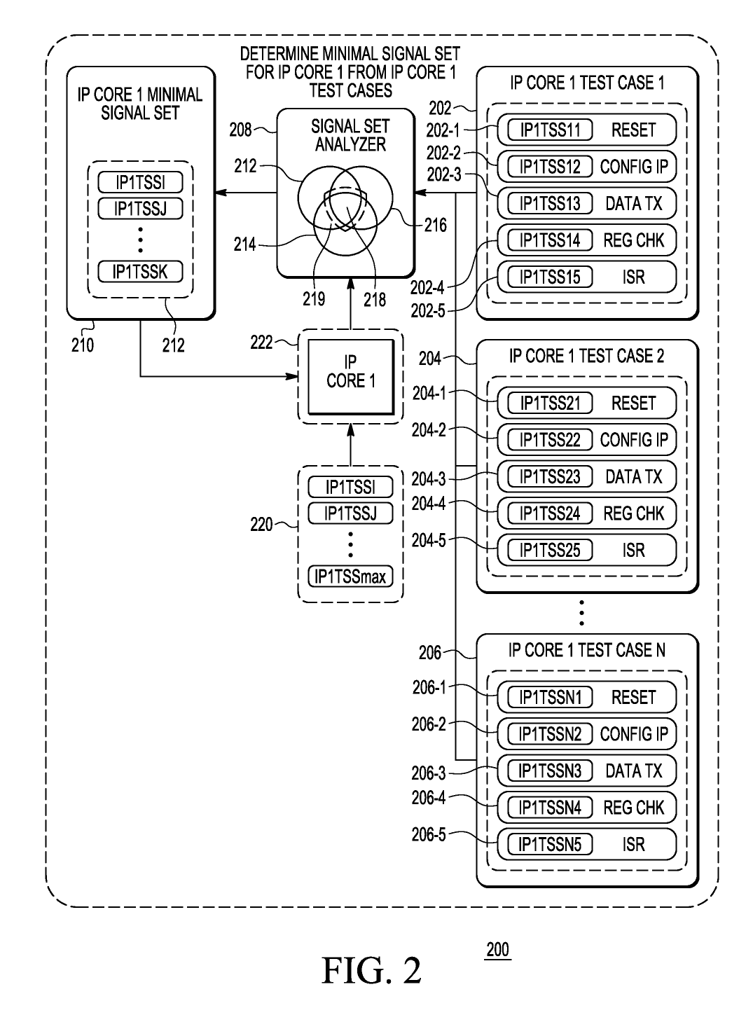

Referring to FIG. 2, there is shown is a view 200 of test signal reduction according to an embodiment of the invention. It can be appreciated that a plurality of test cases 202 to 206 are processed by a signal set analyzer 208 according to an embodiment of the invention. The signal set analyzer 208 can be realized in the form of software or code, that is, as machine executable instructions.

The signal set analyzer 208 is arranged to process a number of IP core test cases with a view to producing a common test case 210 from those IP core test cases. The common test case 210 is derived from the plurality of test cases 202 to 206.

In the illustrated embodiment, the plurality of test cases relates to a common IP core, such as, for example, the first IP core 104-1. However, embodiments are not limited to the common or minimal test case 210 being derived from test cases associated with the same IP core. The test cases 202 to 206 can equally well relate to a number of IP cores such that the common or minimal test case 210 is derived from such test cases associated with such a number of IP cores; the latter can comprise one or more instance of the same IP core and/or one or more instances of different IP cores taken jointly and severally in any and all combinations.

It can be appreciated that the signal set analyzer 208 processes signals sets 212 to 216 of the signals 202-1 to 206-5 of the test cases 202 to 206 to identify or extract a subset 218 of signals for forming the signals of the common test case 210. Embodiment can be realized in which the subset 218 represents the signals common to the plurality of test cases 202 to 206, that is, the intersection of the signals of the test cases.

Alternatively, or additionally, the subset 218 can represent some other subset of signals derived from the signals of the test cases 202 to 206, other than merely the intersection. Such an alternative subset can represent, for example, an expanded intersection 219 of the signals of the test cases, or can represent some other subset of the signals of the test cases 202 to 206.

There are a number of ways that such an expanded intersection, or an expanded or different subset, of signals can be realized. For example, an expanded subset of signals can be realized using at least one of the following: where a number of signals within the intersection toggle, that is, change their state, with signals of other test cases, then those other signals so toggling can be added to the subset of signals, (a signal may be deemed to toggle with another signal if they toggle within a predetermined time threshold of one another), a predefined list of selected signals can be specified for one or more than one IP core of the IP cores that form the SoC for inclusion within the expanded subset of signals, and a history file that stores signals associated with one or more than one IP core of the IP cores that form the SoC. The signals, or one or more than one signal, in the history file can be selected on the basis of having met a predetermined criterion. For example, the frequency of use of each signal over a specified interval can be tracked and, where the frequency of use exceeds a respective threshold, the corresponding signal is or can be included in the expanded subset of signals. The specified interval can be, for example, at least one of a specified time period, a specified number of simulations, or some other span or measure defining a beginning and end of a recording interval over which the frequency of use is noted taken jointly and severally in any and all permutations.

The signal set analyzer 208 is supplied with a description of the signal boundary 220 of the IP core 222 presently under analysis. The signal analyzer 208 is arranged to ensure that at least all signals at the boundary of the IP core 222 are exercised at least once by the subset 210 of signals derived from signals of the test cases 202 to 206. It will be appreciated that such a subset can comprise further signals from the plurality of test cases 202 to 206 in addition to, or as an alternative to, the subset of signals representing the intersection 218 of the sets of signals 212 to 216 of the plurality of test cases 202 to 206. This might be especially the case when, for example, the test signals used as the basis for producing the subset 210 relate to multiple, different, IP cores.

Referring to the test cases such as, for example, the first test case 202, which represents the test case for the first IP core 104-1, it can be appreciated that it comprises a plurality of test signals 202-1 to 202-5. By way of illustration only, the test signals can comprise a reset signal 202-1 for resetting the IP core 222 to a known state, a configuration signal 202-2 for configuring the IP core 222 to a known state, a data transfer signal 202-3 for exchanging data with the IP core 222 in the form of at least one of inputting data to, or outputting data from, the IP core 222, a register check signal 202-4 for checking the status or content of a predetermined register of the IP core 222 and an interrupt service routine signal 202-5 for effecting transfer of control to, or execution of, an interrupt service routine. It will be appreciated that embodiments of the present invention are not limited to the foregoing test signals 202-1 to 202-5. Embodiments can be realized in which other test signals are used in addition to, or as alternatives to, the foregoing test signals 202-1 to 202-5.

It can be appreciated that the other test cases 204 and 206 contain respective test signals 204-1 to 204-5 and 206-1 to 206-5 for exercising the first IP core 222 under respective circumstances, which may or may not have something in common with either one another or the first test case 202.

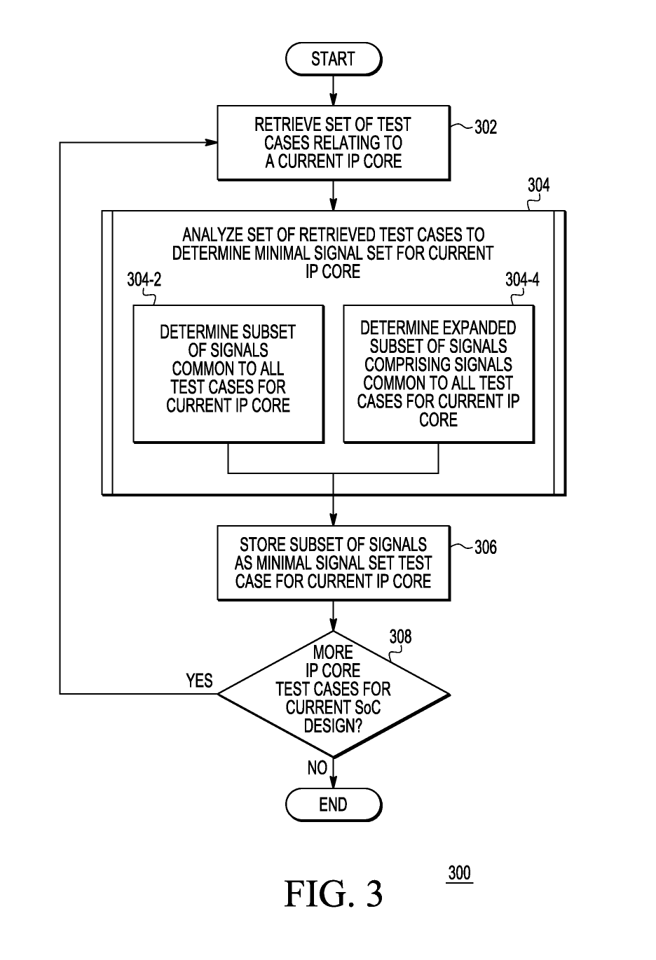

Referring to FIG. 3 there is a flowchart 300 shown for test signal reduction. At step 302, the signal set analyzer 208 retrieves or at least accesses the test cases 202 to 206 associated with a current IP core under test or a current IP core forming part of a SoC under test. The signal set analyzer 208 processes signals 202-1 to 202-5, 204-1 to 204-5 and 206-1 to 206-5 to produce a subset of signals to form the basis of a common test case 210 at step 304. Step 304 can comprise one or more sub-steps that can be used to determine the subset of signals. Step 304-2 determines the subset of signals common to all test cases for a current IP core, or a current SoC, under analysis. Step 304-4 determines an expanded, or alternative, subset of signals as described above. The determined subset of signals is output at step 306 for use in a simulation comprising the current IP core, or the current SoC, or for storage or both. A determination is made at step 308 regarding whether or not there are more IP cores to be processed and, if so, processing resumes at step 302 where the signals of the test cases associated with the next IP core is processed; otherwise processing terminates.

Alternatively, embodiments can be realized in which all IP cores relating to a current SoC are retrieved or at least become accessible or are otherwise made available to the signal set analyzer 208 at step 302. In such an embodiment, the determination at step 308 would be redundant and could be eliminated.

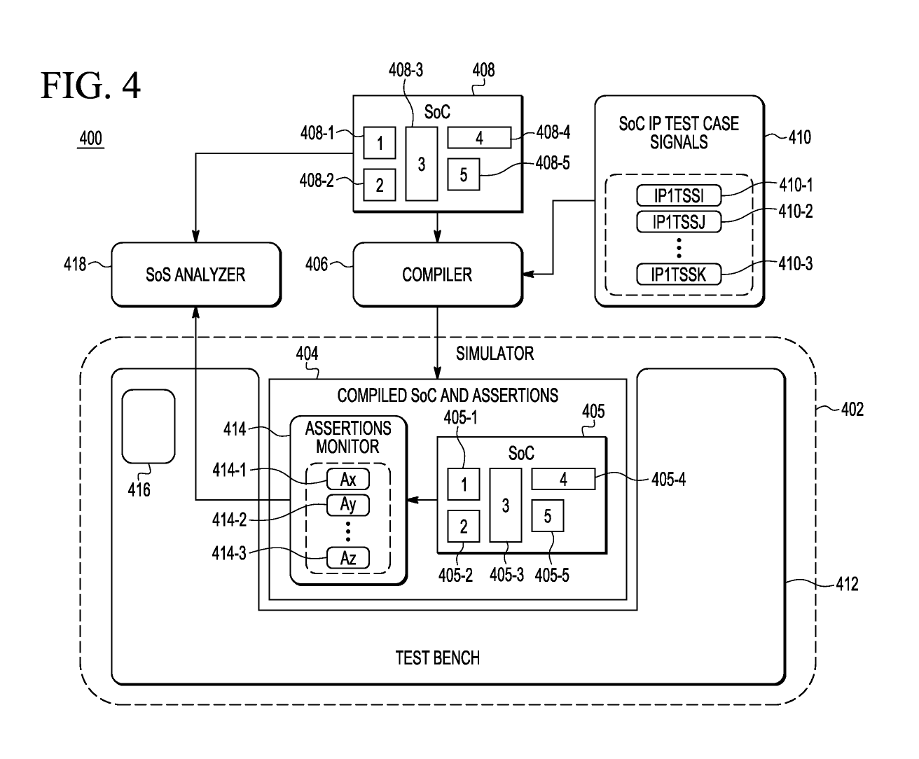

Referring to FIG. 4 is a system 400 shown for analyzing a System-on-Chip description 402, such as, for example, the above described SoC design, according to an embodiment. The system 400 comprises a simulator 402 for processing a compiled SoC expression and associated assertions 405 produced by a compiler 406.

The compiler 406 is arranged to process a SoC description 408 and an associated test case 410 comprising respective test signals 410-1 to 410-3 to produce the compiled SoC and associated assertions 405. The test case 410 can be a test case produced according to any embodiment of the present invention described herein. Alternatively, or additionally, the test case 410 can be a conventional test case. Furthermore, although a single test case is illustrated embodiments are not limited thereto. Embodiments can be realized in which one or more than one test case is used. It will be appreciated that the SoC description is an embodiment of a representation of an integrated circuit design.

The simulator 402 exercises the compiled SoC expression and associated assertions 405 using a test bench 412.

An assertions monitor 414 is arranged to monitor the effect of any assertions on the compiled SoC expression 405 to determine which IP cores of the SoC expression 405 are exercised by the test case 410.

The SoC description 408 is illustrated as comprising a plurality of IP cores; first 408-1 to fifth 408-5 cores in the present example. Therefore, the compiled SoC expression 405 comprises a corresponding number of IP cores 405-1 to 405-5.

The assertions monitor 414 comprises prescribed elements associated with the IP cores 405-1 to 405-5 that are monitored to determine whether or not any activity occurs regarding those monitored elements. In the illustrated example, a plurality of such elements is indicated as can be appreciated from elements 414-1 to 414-3. The elements 414-1 to 414-3 can comprise, for example, at least one of a signal or signals at a signal boundary, an interior element of an IP core, such as, for example, a register or some other aspect of an IP core of the SoC taken jointly and severally in any and all permutations.

The assertions monitor 414 outputs an activity report 416, comprising an indication of any activity detected, for processing by a System-on-Chip analyzer 418. The SoC analyzer 418 processes the activity report 416 to distinguish between IP cores having any associated activity, that is, active IP cores, and IP cores not having any associated activity, that is, inactive IP cores.

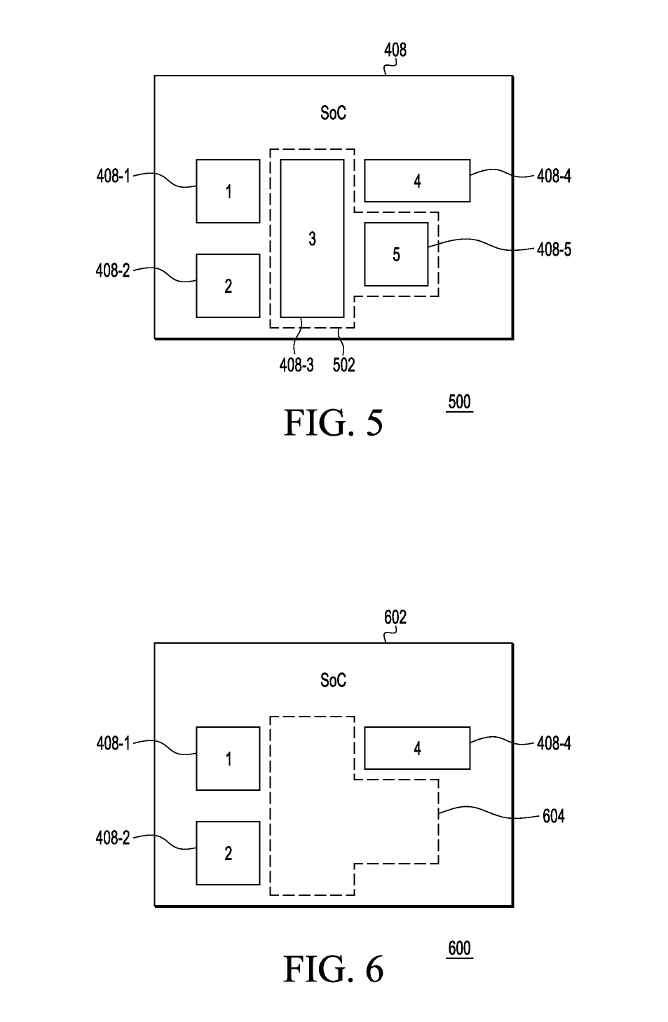

The SoC analyzer 418 uses the at least one of activity report and the SoC description 408 to determine or identify, from at least one of the active IP cores and inactive IP cores, inactive IP cores that can be stubbed as can be appreciated from FIG. 5, which is a view 500 of the SoC description 408 having one or more than one inactive IP core. In the embodiment illustrated, it can be appreciated that two IP cores have been identified as being inactive IP cores, that is, the third 408-3 and fifth 408-5 IP cores. The inactive IP cores 408-3 and 408-5 are identified by a respective stub boundary 502.

Referring to FIG. 6 there is shown a view 600 of a stubbed System-on-Chip description 602 according to an embodiment. The stubbed SoC description 602 is derived from the original SoC description 408 and has the inactive IP cores 408-3 and 408-5 removed. The stubbed SoC description 602 retains the active IP cores 408-1, 408-2 and 408-4. However, the stubbed description 602 retains a signal boundary 604 such as, for example, stub boundary 502, associated with the removed, that is, stubbed, inactive IP cores.

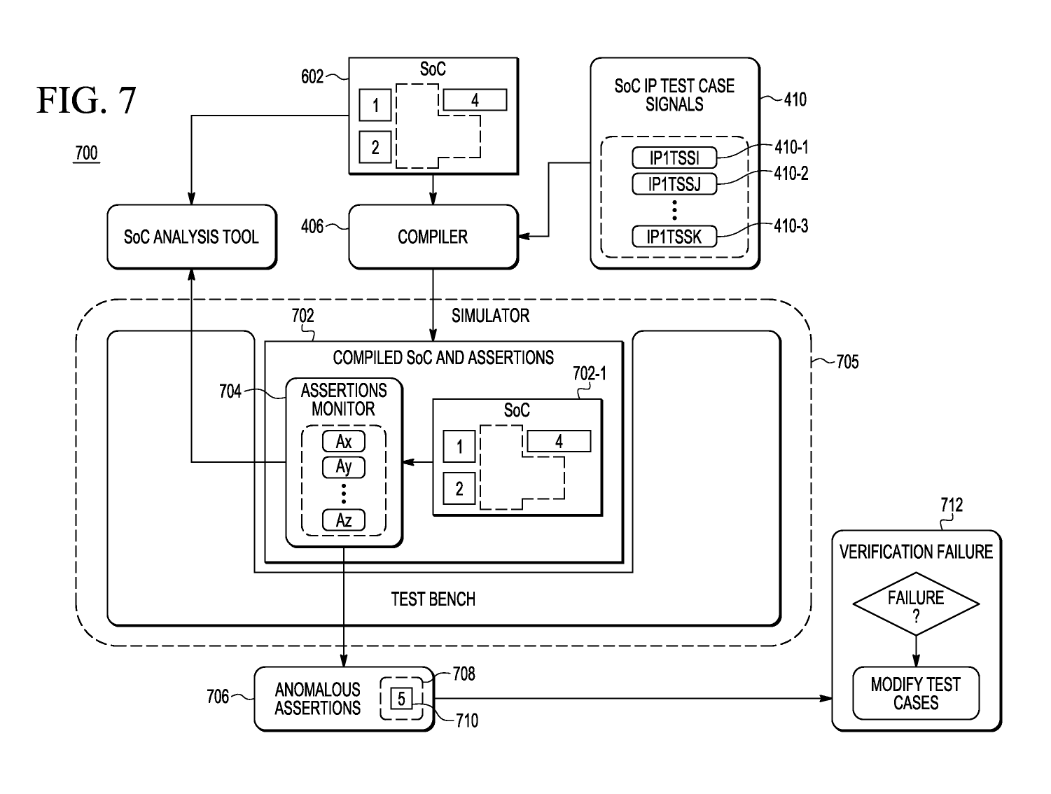

Referring to FIG. 7, a view 700 of the system 400 for verifying the stubbed SoC description 602 according to an embodiment of the present invention is shown. The compiler 406 compiles the stubbed SoC description 602 and the above described test case 410 to produce a compiled studded SoC expression and compiled assertions 702. It can be seen that the stubbed SoC description 602 comprises a plurality of active IP cores, in the present example three active IP cores 408-1, 408-2 and 408-4 and the stub boundary 604, which represents the signal boundary to the inactive IP cores 408-3 and 408-5. One skilled in the art will appreciate that compiling only the active IP cores 408-1, 408-2 and 408-4, or compiling only the active IP cores and the stub boundary 604, will take less compile time as compared to compiling a complete SoC description containing the inactive IP cores. Therefore, the resulting compiled stubbed SoC expression 702-1 is smaller as compared to the original SoC expression 405, since there is a reduced amount of at least one of code and data relating to the inactive IP cores. In some embodiments, at least one of code and data relating to the inactive IP cores can be eliminated from the SoC description 602 and/or the compiled stubbed SoC expression 702-1. However, in other embodiments, additionally or alternatively, all IP cores can remain active if there is no scope for reducing the size of the SoC.

An assertions monitor 704 is provided for monitoring the assertions resulting from the test case 410 and the effect of the assertions associated with the compiled stubbed SoC expression 702-1. The assertions monitor 704 can be configured identically to the above described assertions monitor 414, or configured differently to the above described assertions monitor 414. When testing and verifying the stubbed SoC expression 702-1, that is, when simulating the SoC description 602 using the simulator 705, the assertions monitor 704 monitors the stubbed SoC expression 702-1 to determine whether or not there is any anomalous activity associated with the stubbed inactive IP cores. If any such anomalous activity is detected, an anomalous activity report 706 is produced. The anomalous activity report 706 contains data 708 associated with any detected anomalous activity. The data 708 can comprise, for example, an indication of the inactive IP to which the anomalous activity relates or an indication of an assertion that caused or represented the anomalous activity or both. In the example illustrated, it is assumed that there was anomalous activity relating to the fifth IP core 408-5 and data 710 associated with that anomalous activity is contained within the report 706.

A determination is made by a verifier 712, which is preferably implemented as executable software or code, regarding whether or not the report contains any data relating to anomalous activity. If the verifier determines that the report contains anomalous activity, an output to that effect is produced indicating that the testing and verification of the SoC description 602 has failed. Additionally, the output from the verifier 712 can contain data for modifying at least one of the SoC description 602 and the test case 410.

Preferred embodiments use the common or minimal test case 210 described herein such as with reference to, for example, FIGS. 2 and 3 in conjunction with the stubbed SoC description 602 in the compilation to produce the compiled stubbed SoC expression and associated assertions 702. It will be appreciated that such a reduced test case in conjunction with a reduced SoC expression will result in at least one of a reduced compile time and a reduced runtime during complication and/or simulation.

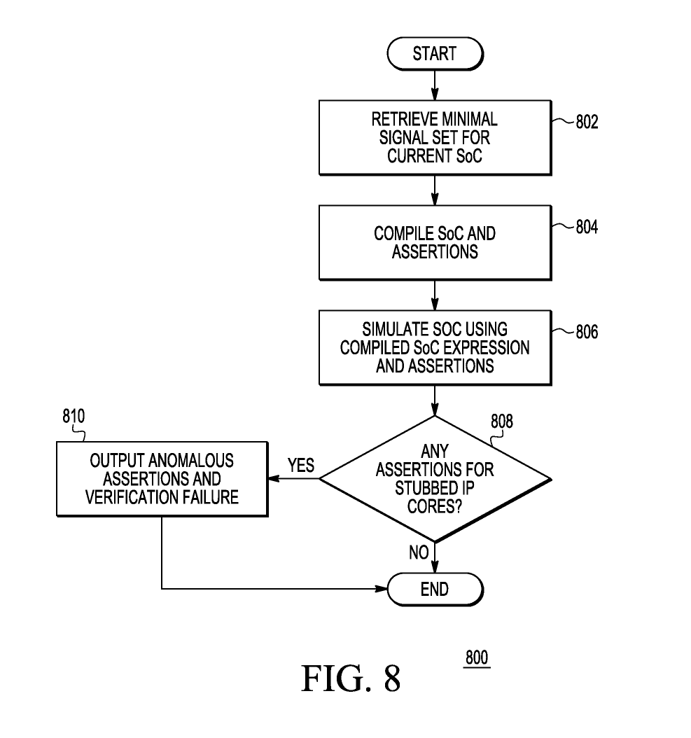

FIG. 8 is a flow chart 800 for verifying a System-on-Chip design according to an embodiment. At step 800, the system 400 is provided with, or accesses, one or more than on test case, preferably the common or minimal test case 210, associated with the stubbed SoC description 602. The stubbed SoC description 602 and the test case 410 or 210 are compiled at step 804. The resulting compiled stubbed SoC expression and assertions 702 are simulated using the simulator 705 at step 806. A determination is made at step 808 regarding whether or not any anomalous activity regarding the inactive IP cores, or stub, was detected. If the determination is negative, the simulation is concluded as being a success and data to that effect is output. If the determination is positive, then the anomalous activity report 706 is output at step 810 for processing by, for example, the verifier 712.

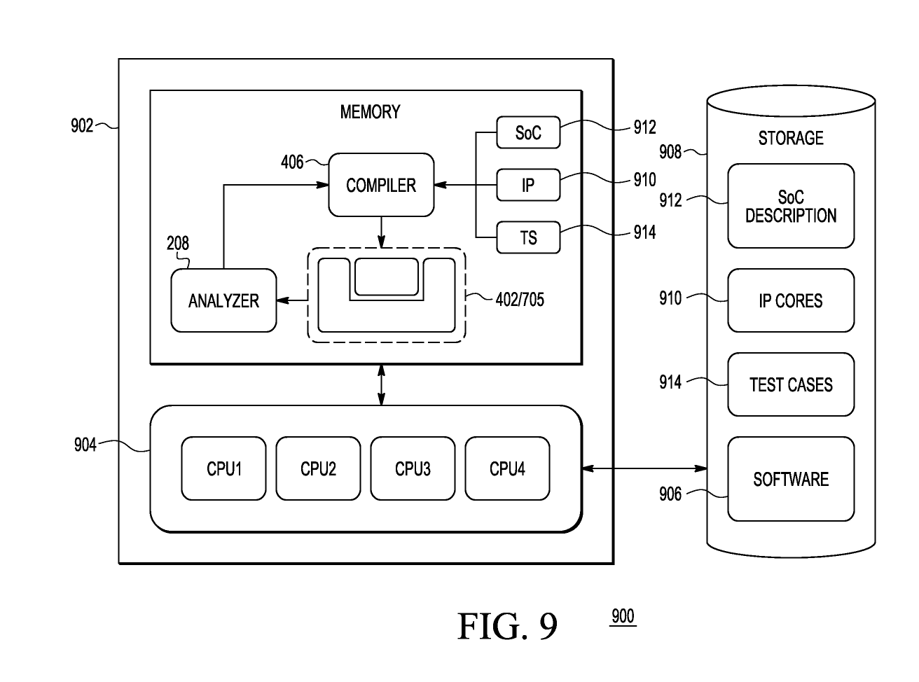

Referring to FIG. 9, a view 900 of a computer system 902 for realising embodiments of the present invention is shown. The above embodiments can be implemented as software that is executable by the computer system 902. The computer system 902 comprises one or more than one processor 904 for executing code or software embodying the above embodiments. The software 906 can be stored also on non-volatile storage 908. Similarly, the code representing the IP cores 910 and the SoC description 912 as well as their associated test cases 914 can be stored in the computer's memory and the non-volatile storage 908. The software 906 comprises the above described compiler 406, signal set analyser 208, SoC analyser 418, simulator and test bench 402 and 705 as well as the assertions monitors.

The embodiments described above indicate that the test cases related to respective IP cores. However, embodiments are not limited to such an arrangement. Embodiments can be realised in which the specific test cases relate to the SoC as a whole or in part or to test cases operable at some other level of granularity of the design or description. It will also be appreciated that at least one of simulation and verification of a design, taken jointly and severally, represents an embodiment of testing a design.

Although the above embodiments have been described with reference at testing and verifying a SoC design, embodiments are not limited to such a level of integrated circuit design granularity. Embodiments can be realized in which the integrated circuit design to be investigated is expressed at some other, higher or lower, level of granularity. For example, it can be appreciated that the above SoC has a number of IP cores. Embodiments can be realized in which the embodiments verify and test individual IP cores, or circuitry or logic at some other level of granularity.

Advantageously, embodiments realize reductions in at least one of compile time, compile size in terms of the amount of code and data needed to perform a simulation and runtime in terms of the amount of processing time and/or processing power needed to run a simulation taken jointly and severally in any and all permutations.

It will be appreciated that the above embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or machine readable storage such as, for example, DVD, memory stick or solid state medium. It will be appreciated that the storage devices and storage media are embodiments of non-transitory machine-readable storage that are suitable for storing a program or programs comprising instructions that, when executed, implement embodiments described and claimed herein. Accordingly, embodiments provide machine executable code for implementing an apparatus, system, device or method as described herein and/or as claimed herein and machine readable storage storing such code. Still further, such programs or code may be conveyed electronically via any medium such as a communication signal carried over a wired or wireless connection and embodiments suitably encompass the same. It will be appreciated that any such software, executing on a processor, to perform a respective function represents an embodiment of processing circuitry to perform that function. Suitably, embodiments provide an apparatus comprising processing circuitry to implement embodiments and methods described and/or claimed herein. The processing circuitry can therefore comprise one or more than one processor suitably programmed to implement the embodiments and methods described and claimed herein or one or more than one processor otherwise suitably configured to implement the embodiments and methods described and claimed herein such as, for example, an ASIC.

Embodiments described herein refer to a set or sets. One skilled in the art will appreciate that a set may comprise one or more than one member.

The description of the embodiments of the present invention has been presented for purposes of illustration and description, but is not intended to be exhaustive or to limit the invention to the forms disclosed. It will be appreciated by those skilled in the art that changes could be made to the embodiments described above without departing from the broad inventive concept thereof. It is understood, therefore, that this invention is not limited to the particular embodiment disclosed, but covers modifications within the spirit and scope of the present invention as defined by the appended claims.

1. A method of testing an integrated circuit design using a computer system that includes a processor and a memory coupled to the processor, the method comprising:
Partitioning, by the processor, a representation of the design stored in the memory into a first set of active elements and a second set of inactive elements following a first exercising of the representation of the design using a first set of simulation signals; and
exercising, by the processor, using a second set of simulation signals, the active elements of the first set of elements during verification of the design.

2. The method of claim 1, wherein the first and second sets of simulation signals are the same.

3. The method of claim 2, wherein partitioning the representation of the design into a first set of active elements and a second set of inactive elements comprises replacing the representation of the second set of elements of the design with a proxy or stub arranged to be unresponsive to exercising with any simulation signals.

4. The method of claim 1, wherein the partitioning of the design comprises identifying at least one signal of the first set of simulation signals that influenced at least one element of the design and classifying the at least one signal as a member of the second set of simulation signals.

5. The method of claim 1, wherein the partitioning of the design comprises identifying at least one element of the design that was influenced by at least one signal of the first set of simulation signals and classifying the at least one element of the design as an active element.

6. The method of claim 1, wherein the partitioning of the design comprises identifying at least one signal of the first set of simulation signals that did not influence at least one element of the design and classifying the at least one signal as being excluded from being a member of the second set of simulation signals.

7. The method of claim 1, wherein the partitioning of the design comprises identifying at least one element of the design that was not influenced by at least one signal of the first set of simulation signals and classifying the at least one element of the design as an inactive element.

8. The method of claim 1, further comprising monitoring at least one of the inactive cores to determine whether any simulation signal attempts to exercise an inactive core, and, in response to detecting an attempt to exercise an inactive core, outputting an indication to that effect and terminating the exercising or testing.

9. A method of testing an integrated circuit design, wherein the integrated circuit design includes a plurality of IP cores, wherein the plurality of IP cores includes a first IP core having a respective first set of test cases, and a second IP core having a respective second set of test cases, wherein the first set of test cases includes a first set of signals associated with a first signal boundary of the first IP core, and the second set of test cases includes a second set of signals associated with a second signal boundary of the second IP core, the method comprising:
reading, by a processor coupled to the memory, the integrated circuit design from a memory in which the design is stored;
deriving, by the processor, from the first set of signals and the second set of signals, a minimal set of signals for exercising the integrated circuit design.

10. The method of claim 9, wherein the deriving comprises identifying signals common to both the first and second sets of signals, and establishing the common signals as the minimal set of signals for exercising the integrated circuit design.

11. The method of claim 9, wherein the deriving comprises identifying signals common to both the first and second sets of signals, identifying at least one further signal in addition to the common signals, and establishing the common signals and the at least one further signal as the minimal set of signals for exercising the integrated circuit design.

12. The method of claim 11, wherein the identifying the at least one further signal in addition to the common signals and establishing the common signals and the at least one further signal as the minimal set of signals for exercising the integrated circuit design comprises at least one of:
identifying a number of such common signals that toggle with one or more other signals and adding one or more than one of those other signals to said minimal set of signals for exercising the integrated circuit design;
identifying a predefined list of selected signals specified for one or more than one IP core of the IP cores of the integrated circuit design and adding one or more than one signal of such an identified predefined list of selected signals to said minimal set of signals for exercising the integrated circuit design; and
identifying one or more than one signal within a history associated with at least one IP core of the integrated circuit design and adding the identified one or more than one signal within the history to said minimal set of signals for exercising the integrated circuit design.

13. The method of claim 9, further comprising exercising the integrated circuit design using the at least minimal set of signals, identifying which cores of the plurality of cores are responsive to the exercising, and classifying any such responsive cores as active cores.

14. The method of claim 9, further comprising exercising the integrated circuit design using the at least minimal set of signals, identifying which cores of the plurality of cores are unresponsive to the exercising, and classifying any such unresponsive cores as inactive cores.

15. The method of claim 9, further comprising modifying the integrated circuit design and exercising the modified integrated circuit design using the at least minimal set of signals.

16. The method of claim 9, wherein modifying the integrated circuit design comprises rendering inactive an IP core of the plurality of IP cores classified as inactive, wherein rendering inactive the IP core classified as inactive comprises stubbing the inactive cores of the integrated circuit design.

17. The method of claim 16, further comprising monitoring the exercising of the modified design using the at least minimal set of signals to identify any attempt to exercise at least one inactive IP core.

18. The method of claim 17, further comprising outputting, in response to identifying any attempt to exercise the at least one inactive IP core, an indication associated with said identifying.

19. The method of claim 9, further comprising exercising the integrated circuit design using the at least minimal set of signals, identifying which cores of the plurality of cores are unresponsive to the exercising, and classifying any such responsive cores as inactive cores.
